(19) United States
(12) Patent Application Publication
(10) Pub. No.: US 2008/0096484 A1
(43) Pub. Date: Apr. 24, 2008

(54) Short range wireless communications using FM band communication links and related systems

(75) Inventors: G. Tyson Tuttle, Austin, TX (US); Peter J. Vancorenland, Austin, TX (US); Wade R. Gillham, Austin, TX (US); Scott D. Willingham, Austin, TX (US); Patrick N. Morgan, Austin, TX (US)

Correspondence Address: TROP, PRUNER & HU, P.C., Suite 750, 1616 S. Voss Road, Houston, TX, 77057, US

(73) Assignee: Silicon Laboratories, Inc., Austin, TX (US)

(21) Appl. No.: 11/824,569

(22) Filed: Jun. 29, 2007

Related U.S. Application Data
(60) Provisional application No. 60/853,082, filed on Oct. 20, 2006.

(51) Int. Cl. H04B 7/00

(52) U.S. Cl. 455/41.2

(57) ABSTRACT

An apparatus includes a transceiver that is adapted to communicate over a wireless communication link with a wireless device using FM band signals having a range of less than approximately fifty feet.

This application claims the benefit under 35 U.S.C. §119(e) to U.S. Provisional Application Ser. No. 60/853,082, entitled, “SHORT RANGE WIRELESS COMMUNICATIONS USING FM BAND COMMUNICATION LINKS AND RELATED SYSTEMS,” which was filed on ______, and is hereby incorporated by reference in its entirety.

### BACKGROUND

The invention generally relates to short range wireless communications using FM band communication links and related systems.

For many electronic devices, such as cellular phones and portable media players, it is often desirable to have short range wireless communications. For example, many cellular handsets can communicate with headsets through short range wireless communications. Currently, Bluetooth (BT) solutions are often provided to accomplish these short range communications. However, BT solutions have cost and power requirement disadvantages.

Systems and methods are disclosed for short range wireless communications using FM band communication links. The disclosed systems and methods provide lower cost and lower power solutions than are provided by existing wireless offerings using technology such as Bluetooth. FM band communication links disclosed herein can be used in a wide variety of applications including wireless headsets and/or hands-free applications for cellular telephone, portable media player or portable gaming device communications, among other portable devices.

### SUMMARY

In an embodiment of the invention, an apparatus includes a transceiver that is adapted to communicate over a wireless communication link with a wireless device using FM band signals having a range of less than approximately fifty feet.

In another embodiment of the invention, a technique includes communicating over a wireless communication link with a wireless device using FM band signals having a range of less than approximately fifty feet.

In another embodiment of the invention, an apparatus includes a transmitter that is adapted to transmit signals in the FM band over a wireless communication link to a wireless device. The signals have a range of less than approximately fifty feet.

In yet another embodiment of the invention, an apparatus includes a receiver that is adapted to receive FM band signals from a wireless communication link. The FM band signals have a range of less than approximately fifty feet from the FM receiver.

Advantages and other features of the invention will become apparent from the following drawing, description and claims.

### BRIEF DESCRIPTION OF THE DRAWING

FIG. 1A is a block diagram of a short range wireless communication system for bi-directional communications between two systems using FM band communication links.

FIG. 1B is a bock diagram of a short range wireless communication system for unidirectional single-direction communications between two systems using FM band communication links.

FIG. 2 is a block diagram for a cellular telephone environment in which a handset and a headset communicate voice and/or data through short range communication links within the FM band.

### DETAILED DESCRIPTION

Systems and methods are disclosed for short range wireless communications of voice and/or data using signals within the FM frequency band to form an FM band communication link between two or more systems. The disclosed systems and methods provide lower cost and lower power solutions than are provided by existing wireless offerings using technology such as Bluetooth.

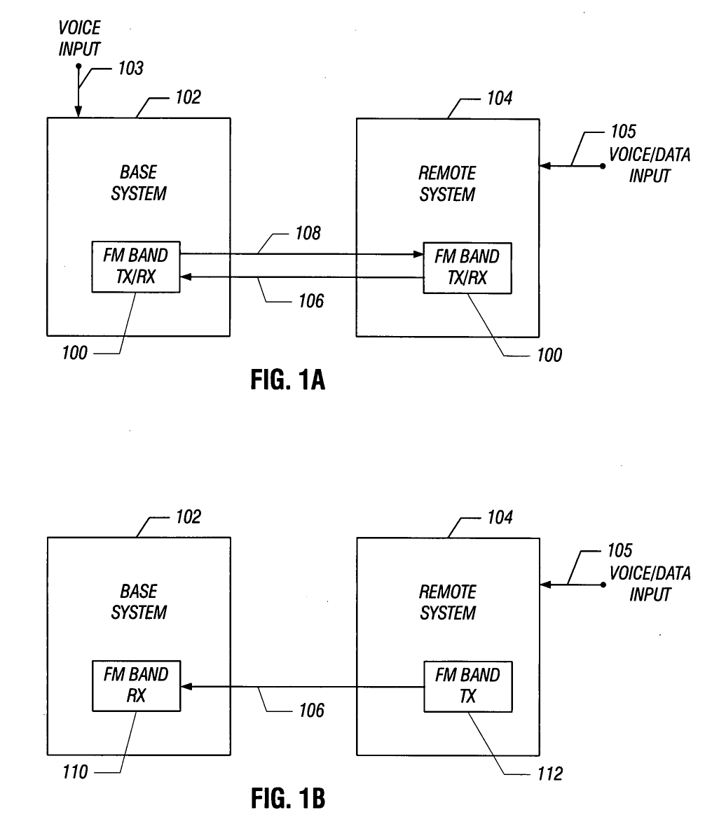

FIG. 1A is a block diagram of a short range wireless communication system for bidirectional communications between two systems using FM band communications. In the context of this application, “short range” means a range of less than approximately fifty feet. Thus, the signals that are described herein as being communicated in the short range wireless communication system have a range of less than approximately fifty feet. As depicted, a base system 102 and a remote system 104 communicate with each other through FM band signals to form an FM band communication link. An integrated circuit 100 within the master system 102 includes FM band transmit (TX) circuitry and FM band receive (RX) circuitry. An integrated circuit 100 within the remote system 104 also includes FM band transmit (TX) circuitry and FM band receiver (RX) circuitry. It is noted that transmit (TX) and receive (RX) circuitry together can be referred to as transceiver (TX/RX) circuitry. Thus, integrated circuit 100 forms an FM band transceiver (TX/RX) integrated circuit.

In operation, the remote system 104 receives voice or data input 105, such as through a microphone that picks up a user's speech and/or through other user input. The remote system 104 then processes the voice and/or data input and uses the FM band TX/RX integrated circuit 100 to transmit voice and/or data content to base system 102 through FM band transmissions 106, thereby providing a short range wireless communication link. The base system 102 receives the FM band transmissions with the FM band TX/RX integrated circuit 100 and processes the voice and/or data content. In turn, the base system 102 can receive voice and/or data input 103, such as through a communication network transmission, such as a cellular network transmission. The base system 102 then processes the voice input and uses the FM band TX/RX integrated circuit 100 to transmit voice and/or data content to remote system 104 through FM band transmissions 108 thereby providing a short range wireless communication link. The remote system 104 receives the FM band transmissions with the FM band TX/RX integrated circuit 100 and processes the voice and/or data content. It is noted that the FM band signals used to form the FM band communication link can be modulated and coded as desired to achieve the operational objectives desired. For example, the signals can be encoded to reduce the likelihood of interception. Any modulation and/or encoding placed on the transmitted FM band signals would then be demodulated and/or decoded upon reception.

FIG. 1B is a bock diagram of a short range wireless communication system for unidirectional single-direction voice and/or data communications between two systems using FM band communication links. This embodiment is similar to FIG. 1A except that FM band transmissions flow only from the remote system 104 to the base system 102. As such, the remote system 104 includes an integrated circuit 112 having FM band transmit (TX) circuitry, and the base system 102 includes an integrated circuit 110 having FM band receive (RX) circuitry. It is further noted that, if desired, remote system 104 could include the FM band TX/RX integrated circuit 100, but only use the transmit (TX) circuitry for FM band communications through link 106. Similarly, the base system 102 could include the FM band TX/RX integrated circuit 100, but only use the receive (RX) circuitry for FM band voice/data communications through link 106. It is also noted that the base system 102 can be any desired electronic device configured to receive signals as part of the FM band communication link, and the remote system 104 can be any desired electronic device configured to transmit signals as part of the FM band communication link. As discussed below, the signals can be modulated and encoded as desired.

This embodiment of FIG. 1B could be utilized, for example, to provide a hands-free device for a car or other environment. For example, a remote system 104, such as a voice pick-up device, can be positioned at a first location, and a base system 102, such as a cellular handset, can be positioned at a second location. The voice pick-up device transmits voice data using its FM band TX integrated circuit 112, and the base system receives 102 receives the FM band transmission using its FM band RX integrated circuit 110. The base system could then utilize the voice data, as desired. For example, the base system could transmit the voice data to other systems through FM band transmissions or could transmit the voice data over other communication protocols, such as cellular protocols. In addition, it is noted that combinations of systems and combinations of unidirectional links and bi-directional links could also be utilized. Other variations and implementations could also be made, as desired.

In a vehicle implementation, for example, the voice pick-up device could be located at any desired position in the vehicle, such as a position in good proximity to the driver of the vehicle. One such location, for example, could be the visor in front of the driver. The base system could be a navigation, entertainment and/or control system for the vehicle. In addition, the base system could be a communication system that further transmits the voice and/or data content. If desired, for example, the base system could further transmit voice/data content through FM band communications to the vehicle radio and/or entertainment systems. In this case, the base system could have an FM band TX/RX integrated circuit 100 and use the TX circuitry to send the voice/data to the vehicle systems. The vehicle systems could include an FM band RX integrated circuit 1 10 for receiving the FM band communication. If desired, the vehicle system could also be configured to output the voice content from the FM band transmissions through the speaker system of the vehicle. This use of the vehicle speakers could be useful, for example, where the base system is a cellular telephone handset. Still further, to improve performance, it is noted that adaptive echo cancellation could be utilized with respect to the microphones discussed herein in order to improve voice pick-up.

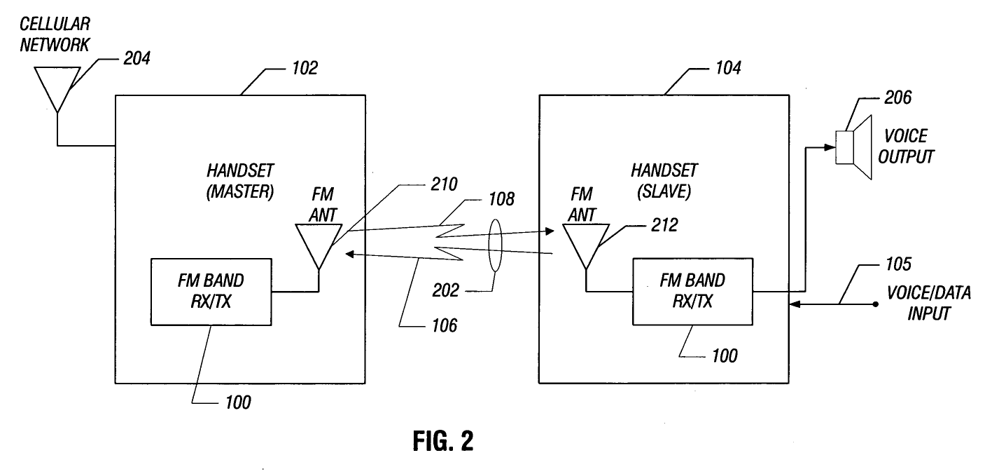

FIG. 2 is a block diagram for a cellular telephone, portable media player, portable gaming device or other portable device environment in which a handset (e.g., relating to the base device discussed above) and a headset (e.g., relating to the remote device discussed above) communicate voice data through short range wireless communications. In this embodiment, the base system 102 is a cellular phone handset and acts as a master device. The handset 102 has antenna 204 that receives and transmits signals to and from a cellular network. As also depicted, handset 102 can include an FM band antenna that is within the handset and that can be integrated within the FM band TX/RX integrated circuit 100, if desired. The remote system 104 is a headset for a cellular phone and acts as a slave device. The headset 104 can also include an FM band antenna that is within the headset and that can be integrated within the FM band TX/RX integrated circuit 100, if desired. As depicted, FM band TX/RX integrated circuit 100 can have an output that is coupled to a speaker 206 to provide a speaker output for a user. It is noted that the speaker 206 is illustrative only. The output to the speaker can be, for example, a mono output such as a left channel audio output signal, or a stereo output utilizing both left and right channel audio output signals. Other variations could also be implemented, if desired.

In operation, the headset 104 receives voice and/or data input 105, such as through a microphone that picks up a user's speech or broadcast data received by the headset. The headset 104 then processes the voice input and uses the FM band TX/RX integrated circuit 100 to transmit voice and/or data content to handset 102 through FM band transmissions 106 thereby providing a short range wireless communication link. The handset 102 receives the FM band transmissions with the FM band TX/RX integrated circuit 100 and processes the voice and/or data content. In turn, the base system 102 can receive voice input from the cellular network through antenna 204. The handset 102 then processes the voice input and uses the FM band TX/RX integrated circuit 100 to transmit voice and/or data content to headset 104 through FM band transmissions 108 thereby providing a short range wireless communication link. The handset 104 receives the FM band transmissions with the FM band TX/RX integrated circuit 100, processes the voice data, and provides an output to the user through speaker 206.

It is noted that the FM band frequency transmissions can be modulated and coded as desired to achieve the operational objectives desired. As examples, such modulations as frequency modulation (FM), Gaussian minimum shift keying (GMSK), frequency shift keying (FSK), etc. may be used, as just a few examples. As depicted, the FM band transmissions 106 and 108 can make up a wireless voice/data link 202 between the handset 102 and the headset 104. If desired, this data link 202 can be digitally modulated. In addition, this data link 202 can be encrypted, if desired, to reduce the possibility of a third party intercepting the transmissions.

In general, therefore, an FM band transceiver is included in a first device (e.g., the handset), and an FM band transceiver is included in a second device (e.g., the headset) so that an FM band wireless communication bi-directional or unidirectional link can be established for short range communications. If desired, an integrated antenna, such as a loop or short stub, can be used on both devices, for example, if there were no headphone cable that could be utilized. Duplex communications can be provided using time division duplexing (TDD) and/or frequency division duplexing (FDD) to avoid interference and/or reduce current consumption. With respect to TDD, some digital modulation, such as GMSK, could be used to save power consumption and also to achieve some level of security to prevent eavesdropping. Analog FM modulation could be used with FDD. However, with respect to FDD, a hybrid circuit could be used to separate the RX signal from the TX signal (˜1 Vrms). While it would be desirable to use a single local oscillator (LO) within the FM band TX/RX integrated circuit 100 for both transmit and receive operations, a different intermediate frequency (IF) could be used for the transmit and receive operations in a low-IF architecture.

With respect to the handset, a digital audio interface could be utilized similar to a Bluetooth (BT) chip, such as a PCM interface or an 12S interface. Analog to digital converters (ADCs) within the FM band TX/RX integrated circuit 100 for the handset can be used for receive operations, and digital to analog converters (DACs) within the FM band TX/RX integrated circuit 100 for the handset would be used for transmit operations.

With respect to the headset, communications with a microphone and earphone speaker could be accomplished using a microphone amplifier and a headphone driver. In addition, battery management features could also be provided for the headset, and integrated with the FM band TX/RX integrated circuit in some instantiations. The additional circuitry could also be provided in addition to the FM band TX/RX integrated circuit 100, if desired, to facilitate the operation of the headset (or the handset). If the additional circuitry were included in an integrated circuit, this IC could be combined with the FM band TX/RX integrated circuit 100 into an MCM (multi-chip module), if desired.

As described here, therefore, an FM transmitter and FM receiver are used to create a voice and/or data connection between two devices to pass wireless voice and/or data back and forth between the two devices. The described solutions provides a replacement for traditional “wired” and Bluetooth (BT) wireless connections, such as are found with respect to headsets for many cell phones, portable media players, portable audio devices, or other portable devices. Each device has a FM transceiver, or both an FM receiver and an FM transmitter. In other words, for bi-directional communications, each device has the ability to both transmit and receive content in the FM band through the FM communication link. It is further noted that a device can only have an FM transmitter or an FM receiver, for example, if a unidirectional implementation is desired.

While the signal for the wireless communication links discussed here will typically be in the FM frequency band, it can be modulated and encoded, as desired, for the wireless short range communication link between the base system and the remote system discussed above. It is noted that within the United States, FM audio broadcast signals are broadcast in 200 KHz channels in the frequency band from 88 MHz to 108 MHz. European FM stations fall within a similar frequency range with 100 KHz channels. Japanese FM stations are from 71 to 91 MHz.

The FM band TX/RX integrated circuit 100 can be configured to provide audio broadcast reception within a frequency band, such as the FM band, and to provide wireless voice/data communications on a modulated signal having a frequency within the same frequency band. The signal modulation for this wireless voice/data signal, however, need not be standard FM modulation as used for audio broadcasts. The operational control of the FM band TX/RX integrated circuit 100 can be provide, for example, through software control, if desired.

Device applications for these disclosed embodiments include, but are not limited to, cellular handset plus wireless headset applications, portable media player plus wireless headset applications, portable audio player plus wireless headset applications, portable gaming devices plus wireless headset applications, portable data management devices plus wireless headset applications, push-to-talk or walkie-talkie plus wireless headset applications, portable CD players plus wireless headset applications, or consumer electronics plus wireless headset applications. Other embodiments and applications could also be implemented if desired.

If desired, one device can be the master device, and one device can be the slave device. The master can be configured to dictate when the slave transmits and receives. The master can also dictate the security mechanism and process. Further, the master can dictate the transmit and receiver frequencies within the FM band.

With respect to security, an association mechanism can be utilized. For example, the two devices can be re associated to one another using an automatically generated, manufacturer loaded, or user-generated code. The two devices can associate and remain so unless completely powered down with no reserve battery power. In the case of the devices becoming unassociated due to complete power down, the association can be reset to a factory-installed setting and then be ready for reset. The association security mechanism is for association of the two devices.

To connect, the two devices can be programmed to follow a particular handshake, recognition or configuration routine. For example, the master device could scan the FM band for low power FM broadcast signals, and then select an FM frequency based on predetermined criteria and send the target frequency for the data connection to the slave device. The slave device could then tune to the target frequency and data exchange could begin.

As discussed above, digital modulation can be used for the wireless communication link. For example, digital modulation can be used to carry the data. GFSK, GMSK, or OFDM in conjunction with TDD (time domain division) frequency management can be used to further increase security and quality of voice and/or data transferred.

Further, if desired, data communications between the two FM transceivers can be encrypted using a simple overlay to the modulation. The two devices can share an encryption key that is refreshed with each new connection, or maintained from initial synchronization.

With respect to antennas, the devices could use an integrated tuned antenna, such as a loop or short stub. Each device would therefore use its FM transceiver to tune the antenna to the desired frequency.

FM interference can be managed by monitoring the receive channel for FM modulated signals. FM modulated signals will be different than the data connection between the two FM transceivers. However, if an FM modulated signal is received above a pre-determined SNR threshold, the master FM receiver can scan the FM band for received power levels and dictate a new tuned frequency to the slave FM receiver, which will tune to the new frequency. Other implementations can also be used to monitor and reduce interference, if desired.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. An apparatus comprising:
a transceiver adapted to communicate over a wireless communication link with a wireless device using FM band signals having a range of less than approximately fifty feet.

2. The apparatus of claim 1, further comprising:
a device to generate content to be communicated by the transceiver, the device being hardwired to the transceiver.

3. The apparatus of claim 2, wherein the device comprises a device selected from a set comprising a cellular telephone, a portable media player and a portable gaming device.

4. The apparatus of claim 2, wherein the device and the transceiver are part of the same semiconductor package.

5. The apparatus of claim 1, further comprising:
a microphone and a speaker coupled to the transceiver.

6. The apparatus of claim 5, wherein the apparatus comprises a wireless headset.

7. A method comprising:
communicating over a wireless communication link with a wireless device using FM band signals having a range of less than approximately fifty feet.

8. The method of claim 7, wherein the wireless device comprises a device selected from a set comprising a cellular telephone, a portable media player and a portable gaming device.

9. The method of claim 7, wherein the communicating comprises performing at least one of transmitting to and receiving from a device selected from a set comprising a cellular telephone, a portable media player and a portable gaming device.

10. The method of claim 7, wherein the act of communicating comprises:
communicating over a bidirectional wireless communication link.

11. The method of claim 7, wherein the act of communicating comprises:
communicating data between a cellular telephone and a wireless headset.

12. The method of claim 7, wherein the act of communicating comprises:
communicating data over a unidirectional communication link.

13. The method of claim 7, wherein the act of communicating comprises receiving content from the communication link.

14. The method of claim 7, wherein the act of communicating comprises transmitting content to the communication link.

15. An apparatus comprising:
a transmitter adapted to transmit signals in the FM band over a wireless communication link to a wireless device, the signals having a range of less than approximately fifty feet.

16. The apparatus of claim 15, further comprising:
a device to generate content to be communicated by the transmitter, the device being hardwired to the transmitter.

17. The apparatus of claim 15, wherein the device comprises a device selected from a set comprising a cellular telephone, a portable media player and a portable gaming device.

18. The apparatus of claim 15, wherein the device and the transmitter are part of the same semiconductor package.

19. The apparatus of claim 15, further comprising:
a microphone and a speaker coupled to the transmitter.

20. An apparatus comprising:
a receiver adapted to receive FM band signals from a wireless communication link, the FM band signals having a range that is less than approximately fifty feet from the receiver.

21. The apparatus of claim 20, further comprising:
a device to process content indicated by the FM band signals, the device being hardwired to the receiver.

22. The apparatus of claim 21, wherein the device comprises a device selected from a set comprising a cellular telephone, a portable media player and a portable gaming device.

23. The apparatus of claim 21, wherein the device and the receiver are part of the same semiconductor package.

24. The apparatus of claim 20, further comprising:
a microphone and a speaker coupled to the receiver.
